(19) United States
(12) Patent Application Publication
(10) Pub. No.: US 2009/0259938 A1
(43) Pub. Date: Oct. 15, 2009

(54) DEVICE SETTING SYSTEM

(75) Inventors: Seiichiroh Tachibana, Nara (JP); Masanori Matsumoto, Nara (JP); Takeshi Nakamura, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/410,913

(22) Filed: Mar. 25, 2009

(30) Foreign Application Priority Data
Apr. 14, 2008 (JP) 2008-104984

(51) Int. Cl. G06F 3/048; G06F 15/16

(52) U.S. Cl. 715/709; 709/203

(57) ABSTRACT

A PC performs a setting for an MFP capable of mounting various optional equipments. The PC has a storage portion for storing descriptions of various functions of the MFP, a mounted state of the optional equipments and setting instruction information on the respective functions, and storing parts where the descriptions exist for each of the functions, and a display control portion in which, at the time of displaying the descriptions, a display form is differentiated between a case where the description about the functions mounted with the MFP is displayed and a case where the description about a function not mounted is displayed, and when the description about the mounted functions are displayed, a setting instruction receiving portion for the functions is displayed together. When an instruction for the setting is received by the setting instruction receiving portion, the PC transmits the setting instruction information for the functions to the MFP.

### CROSS-NOTING PARAGRAPH

This non-provisional application claims priority under 35 U.S.C. §119(a) on Patent Application No. 2008-104984 filed in JAPAN on Apr. 14, 2008, the entire contents of which are hereby incorporated herein by reference.

### FIELD OF THE INVENTION

The present invention relates to a device setting system constituted by connecting a device capable of mounting an optional equipment and a device setting apparatus.

### BACKGROUND OF THE INVENTION

An instruction manual is usually provided with a device as a product in a form of paper, and when a user who bought the device installs the device or does not know how to operate, the user actually takes the instruction manual in hand and confirms the contents. However, as the number of functions provided with the device increases, the thicker and bulkier the instruction manual becomes. In a case where there is no space to put the instruction manual in operating the device and the like, the user is forced to hold the heavy instruction manual with one hand and operate the device with one hand while turning the pages, and also to move eyes, which is a burden on the user. In addition, there are cases where a plurality of volumes of thick instruction manuals are provided for some devices, and it is difficult to secure the storage area for the instruction manuals.

When the instruction manual is provided in a form of an electronic file as a CD with a product, the storage space for the instruction manual is easily secured. Moreover, in such a case, a user causes a personal computer (PC: Personal Computer) to read the electronic file of the instruction manual, and a display screen thereof to display the instruction manual of the product that has been bought to confirm how to operate a device. However, even in this method, when the device is actually operated, it is necessary to output the contents of the display screen to paper in advance, which is a burden on the user.

Japanese Laid-Open Patent Publication No. 2005-115462 describes about a thick and bulky instruction manual as one of problems to be solved and discloses a help display apparatus in which, when a user touches an operation icon that is displayed on a display portion with descriptions of the operation contents by connecting a device to operate, an operation guide to execute a subsequent operation is displayed.

Furthermore, as a device such as a multifunction peripheral has more advanced functions, a wide variety of mountable optional equipments (for example, a 2-sided conveying apparatus, a post-processing apparatus and the like) are commercialized, and the instruction manual thereof often includes the contents relating to an optional equipment that is not actually mounted.

### SUMMARY OF THE INVENTION

An object of the present invention is to provide a device setting system in which, when a device is set, while referring to an instructional description displayed in a form corresponding to a mounted state of an optional equipment to the device, a setting of contents as they are displayed is reliably executable.

Another object of the present invention is to provide a device setting system constituted by connecting a device capable of mounting various optional equipments and a device setting apparatus provided with a display portion, wherein the device setting apparatus comprising: a storage portion for storing an instruction manual including descriptions of various functions of the device, a mounted state of the optional equipments of the device and setting instruction information on the respective functions, as well as storing parts where the descriptions of the functions exist in the instruction manual for each of the functions; a display control portion in which, at the time of displaying the descriptions on the display portion, a display form is differentiated between a case where the description about the functions mounted with the device is displayed and a case where the description about a function not mounted is displayed, and when the description about the functions mounted with the device is displayed, a setting instruction receiving portion for receiving an instruction for a setting of the functions is displayed together; and a transmitting portion in which, when the setting instruction receiving portion receives the instruction for the setting, the setting instruction information for the functions is transmitted to the device; and the device comprising: a receiving portion for receiving the setting instruction information; and a setting portion for performing the setting of the functions to the device based on the setting instruction information thus received.

Another object of the present invention is to provide the device setting system, wherein the instruction manual further includes contents relating to the optional equipments, the storage portion stores parts where the contents relating to the optional equipments exist in the instruction manual for each of the optional equipments, and when displaying the contents relating to the optional equipments, the display control portion differentiates a display form between a case where the contents about the optional equipments mounted with the device are displayed and other cases.

Another object of the present invention is to provide the device setting system, wherein the transmitting portion temporarily stores the setting instruction information and transmits a plurality of the setting instruction information collectively to the device.

### BRIEF DESCRIPTION OF THE DRAWINGS

FIG. 1 is a schematic structural view showing an example of a device setting system according to an embodiment of the present invention;

FIG. 2 is a view showing an example of a display form when an instruction manual of an MFP according to the present invention is displayed;

FIG. 3 is a view showing another example of a display form when the instruction manual of the MFP according to the present invention is displayed;

FIG. 4 is a view showing an example of a screen displayed when a function of the MFP according to the present invention is performed;

FIG. 5 is a flowchart illustrating an example of processing at a PC 1 and an MFP 2 when a setting of the MFP 2 is remotely made from the PC 1 of FIG. 1; and

FIGS. 6A and 6B are views showing a state of an operation portion in the MFP in a device setting according to the present invention.

### PREFERRED EMBODIMENTS OF THE INVENTION

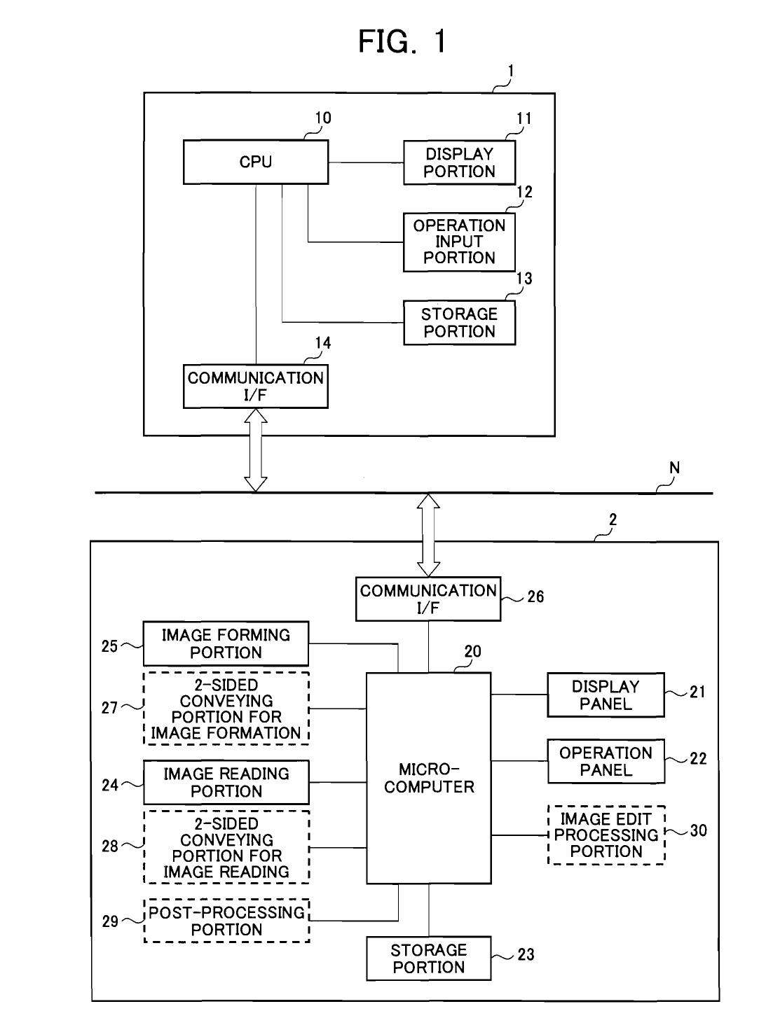

FIG. 1 is a schematic structural view showing an example of a device setting system according to an embodiment of the present invention. The device setting system of the present invention is constituted by connecting a device capable of mounting various optional equipments, and an apparatus for performing a setting of the device (device setting apparatus). In an example of the device setting system in the figure, a personal computer (PC) 1 as a device setting apparatus and a digital multifunction peripheral (MFP: Multi-function Peripheral) 2 as the above-described device are connected by a network N such as a LAN (Local Area Network).

The PC 1 includes a CPU 10 for executing various calculating processing to control functions of the entire PC 1, a display portion 11 such as a liquid crystal display for displaying various information, an operation input portion 12 for receiving an operation from a user, a storage portion 13 consisting of a RAM for storing temporal information accompanied with the calculating processing and the like, a hard disk for storing other information (for example, a program) and the like, and a communication I/F 14 for communicating with the MFP 2 through the network N or the like.

The MFP 2 includes a micro-computer 20 consisting of a CPU for performing calculation, a RAM for storing temporal information accompanied with the calculation and the like, a display panel 21 such as a liquid crystal panel for presenting various information to a user, an operation panel 22 for receiving an operation from the user, a storage portion 23 for storing various information such as a control program to control the MFP 2, an image reading portion 24 for reading an original image recorded on a recording sheet, an image forming portion 25 for forming image data on the recording sheet, and a communication I/F 26 for communicating with the PC 1 through the network N or the like. With the respective portions described above, the MFP 2 is capable of operating, for example, as a copier, a network scanner apparatus or the like.

Furthermore, the MFP 2 is capable of mounting, as optional equipments, a 2-sided conveying portion for image formation 27 that conveys a recording sheet to the image forming portion 25 so as to be capable of forming images on both sides of the recording sheet, a 2-sided conveying portion for image reading 28 that conveys an original to the image reading portion 24 so as to be capable of reading both sides of the original, a post-processing portion 29 for stapling the recording paper on which an image has been formed or punching a hole thereon, and an image edit processing portion 30 capable of executing a security function (encrypting data stored in an HD, deleting data) and/or a character recognition function for data read by the image reading portion 24 and the like. A mounted state of these optional equipments can be stored and managed by the storage portion 23.

The device setting system having the configuration as described above has the following characteristics. That is, there are characteristics in that the PC is capable of displaying an instruction manual of the MFP 2 containing a series of descriptions in an optimum form in accordance with the mounted state of the optional equipments of the MFP 2, and while referring to the displayed instructional descriptions, a user is capable of remotely and reliably setting the contents as they are displayed. To enable them, the PC 1 and the MFP 2 operate as follows using the respective portions described above.

In the PC 1, the storage portion 13 as a “storage portion” of the present invention stores information on the instruction manual. The information on the instruction manual is the same as the one conventionally provided as an electronic file (PDF file), and the instruction manual contains at least descriptions of a method for setting and operating functions, as well as, descriptions of the functions, a method for dealing with troubles and the like. Further, the storage portion 13 stores page number information for each apparatus in which page numbers of the instruction manual to be displayed are shown for each optional equipment. Furthermore, the storage portion 13 stores the mounted state (mounted state information) of the optional equipments of the MFP 2. The mounted state information is obtained, for example, from the MFP 2.

In the PC 1, when a request for a remote setting of the MFP2 or a request for displaying the instruction manual of the MFP 2 is received, based on the instruction manual information, the mounted state information, and the page number information for each apparatus, which have been described above, the CPU 10 controls the contents independent from a presence/absence of the mounted optional equipment and the contents relating to the mounted optional equipment so as to be normally displayed (or displayed in conjunction with a setting instruction receiving portion described below), and controls other contents in the instruction manual so as not to be normally displayed.

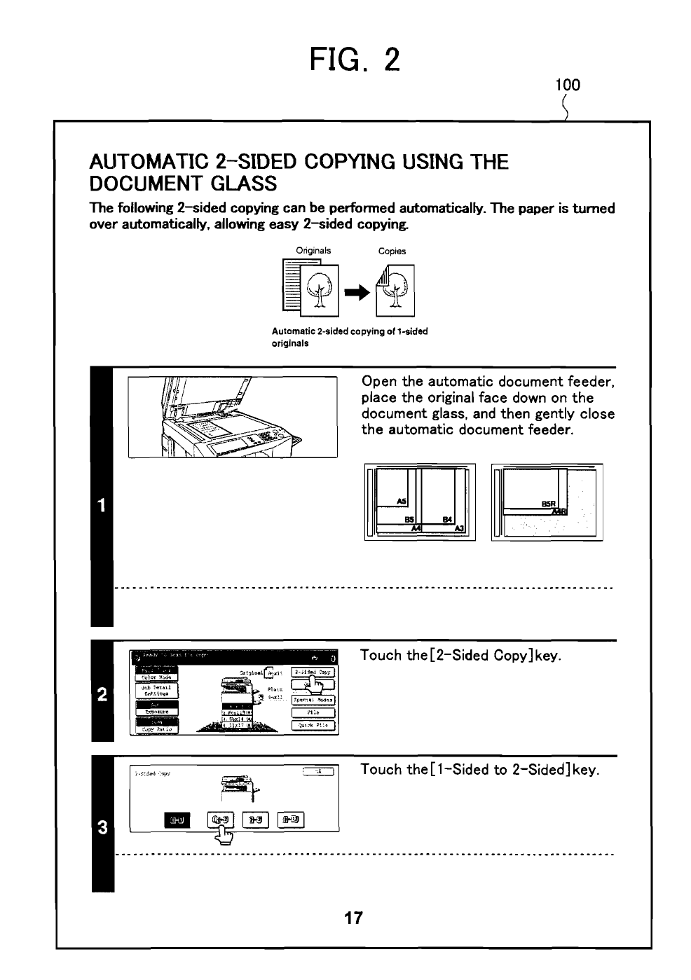

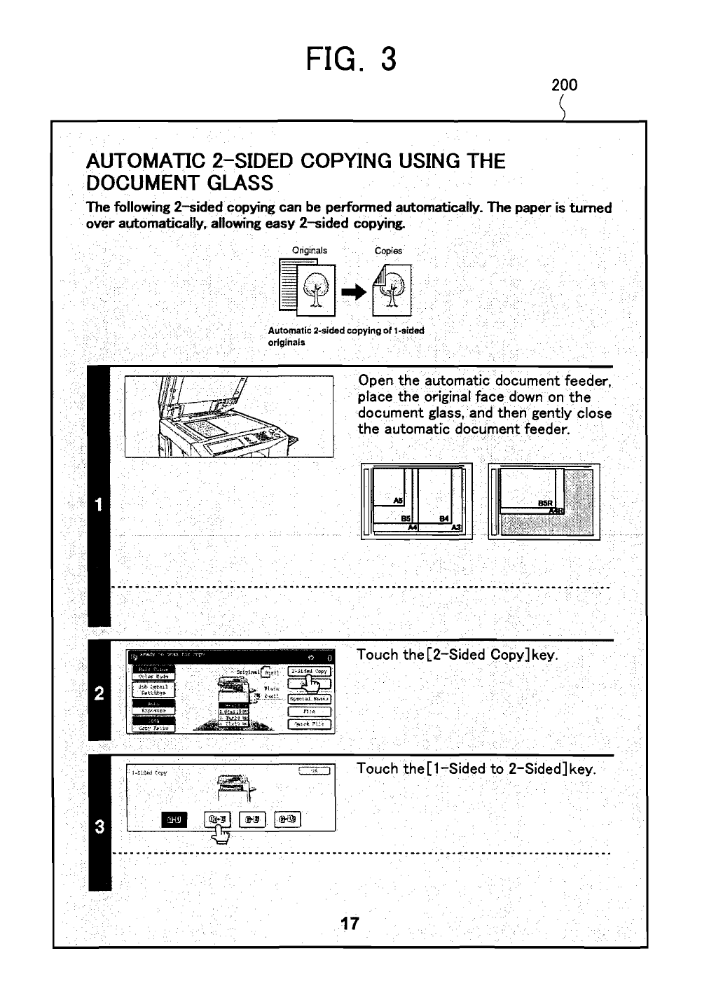

For example, when the 2-sided conveying portion for image formation 27 is mounted as an optional equipment, descriptions of how to make a 2-sided copy as the contents relating to the conveying portion 27 are displayed, as shown in a screen 100 of FIG. 2, in a form similar to the conventional display for the instruction manual. Further, when the conveying portion 27 is not mounted, for example, as shown in a screen 200 of FIG. 3, instead of the normal display, a mask-display is performed. In this way, by differentiating the display form of the instruction manual depending on the mounted optional equipment, a user is capable of recognizing at a glance that the operation based on the currently displayed contents on the display screen is not executable, and the like.

To enable this display, the CPU 10 creates (obtains) information on a page number subjected to the mask-display (mask information) based on the mounted state information and the page number information for each apparatus, and causes the storing portion 13 to store. The CPU 10 performs display control based on information on the instruction manual and the like, and, at that time, obtains a number of a currently displayed page. Thus, the CPU 10 is capable of determining for each page whether to cause the display screen of the instruction manual to be mask-displayed, based on the page number and the mask information.

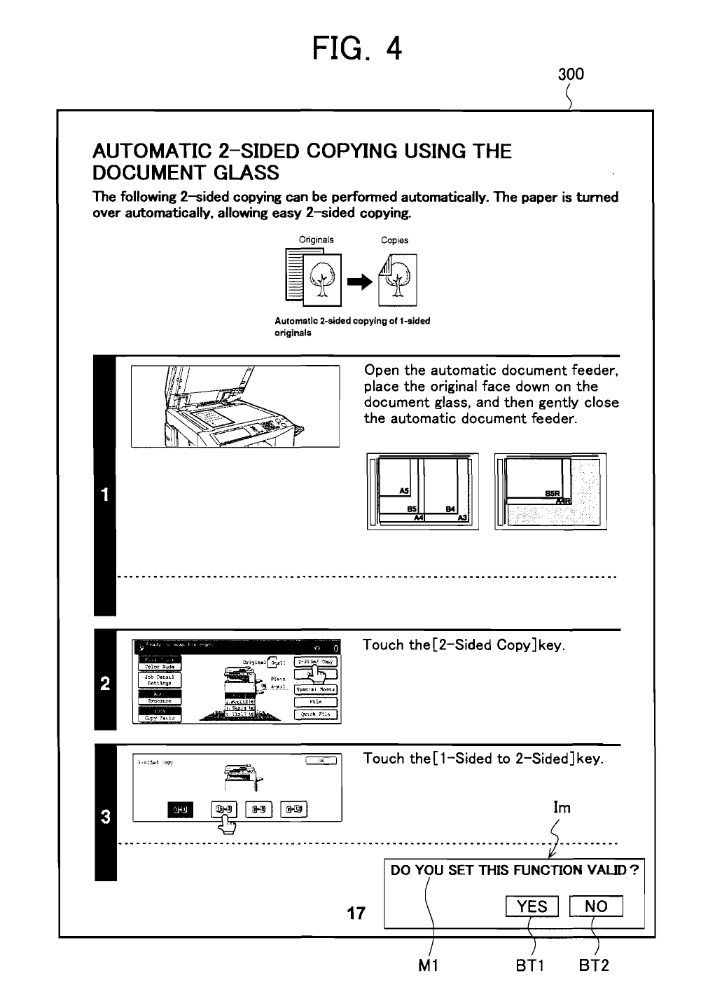

Further, in the PC 1, when a request for the remote setting of the MFP 2 is made, the CPU 10 performs display control, and as shown in a screen 300 of FIG. 4, when descriptions of the functions of the MFP 2 or a method for setting the functions are displayed on the display portion 11, a setting instruction receipt relevant image Im including an “YES” button BT 1 as the setting instruction receiving portion is displayed. Further, in the PC 1, together with the “YES” button BT 1 as the setting instruction receipt relevant image Im, a message Ml for asking whether to set the function being displayed (“Do you set this function valid?”) and a “NO” button BT 2 are also displayed.

In the PC 1, in order to enable the display of the screen 300, the storage portion 13 stores information for a relevant image to display the setting instruction receipt relevant image. The information for a relevant image describes a page number of the instruction manual subjected to a display of a method for setting functions (that is, the page number subjected to a display of the setting instruction receipt relevant image) is described. The information for a relevant image is included, for example, in an application for a remote setting.

In the PC 1, based on the information for a relevant image, the mask information and the number of the currently displayed page, the setting instruction receipt relevant image Im (that is, the setting instruction receiving portion) can be displayed as described above.

As described above, in the PC 1, the CPU 10 functions as a “display control portion” of the present invention.

The user using the present device setting system refers to the contents of the screen 300, confirms the function being displayed, and when desires to validate the function in the MFP 2, depresses the “YES” button BT 1. The CPU 10 of the PC 1 detects the depressing operation by the operation input portion and receives a setting instruction for the function being displayed from the user.

The storage portion 13 stores setting instruction information to instruct, for each function to be set, a setting of the function, and the CPU 10 receives the setting instruction and thereafter extracts the setting instruction information on the function being displayed on the screen 300. For this extraction, in order that the CPU 10 is capable of specifying the function being displayed, based on the page number subjected to a display of the setting instruction receipt relevant image Im, with reference to the above-described information for a relevant image, the information for a relevant image shows, for each page number, the function to be displayed on the page. The CPU 10 transmits the extracted setting instruction information through the communication I/F 14 to the MFP 2. In this way, the CPU 10 functions as a “transmitting portion” of the present invention.

Note that, since there is also a case where a plurality of functions are set, the PC 1 is also capable of temporarily registering (storing) the setting instruction information in the storage portion 13 so as to transmit collectively.

With respect to the PC 1 that operates as described above, the MFP 2 operates as follows. That is, in the MFP 2, the micro-computer 20, as a “receiving portion” of the present invention, receives the setting instruction information of the function that has been displayed from the PC 1 through the communication I/F 26. When the function of the MFP 2 that has been displayed on the display portion 11 of the PC 1 is not set, the micro-computer 20, as a “setting portion” of the present invention, is capable of performing a setting of the function based on the received setting instruction information.

In this way, it is possible to remotely set the contents (functions) of the instruction manual displayed on the display screen of the PC 1 to the MFP 2, thereby a burden on the user can be significantly reduced.

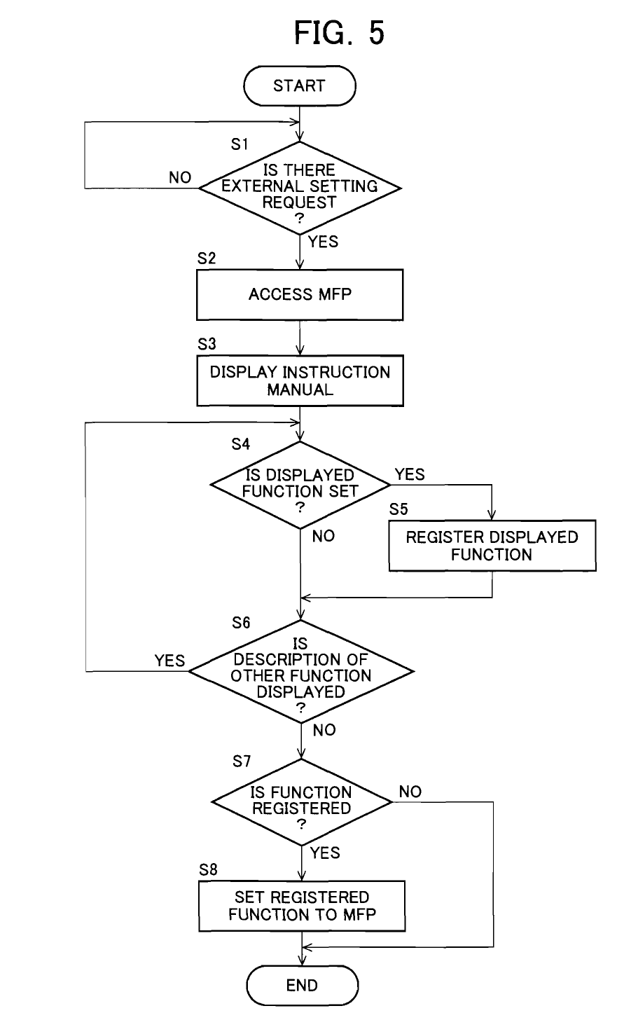

FIG. 5 is a flowchart illustrating an example of processing in the PC 1 and the MFP 2 when a setting of the MFP 2 is remotely made from the PC 1 of FIG. 1.

The PC 1 determines whether or not a remote setting request (external setting request) is made by a user, for example, based on whether or not a predetermined application (application for a remote setting) is activated (step S1). When the remote setting request is not made (in the case of NO), the procedure returns to step S1, whereas, when the remote setting request is made (in the case of YES), the MFP 2 is accessed through the network N (step S2) so as to obtain the instruction manual information, the mounted state information (option information) and the page number information for each apparatus to store in the storage portion 13, and the procedure proceeds to step S3. Note that, when the information for a relevant image is stored in the MFP 2, but is not held in the storage portion 13 in advance, the PC 1 obtains the information for a relevant image at step S2. Since the processing at step S2 is for obtaining the instruction manual information and the like, when the storage portion 13 stores them in advance, the processing can be skipped.

At step S3, based on the mounted state information and the page number information for each apparatus stored in the storage portion 13, the PC 1 creates mask information to store in the storage portion 13, and based on the mask information, the instruction manual information and the information for a relevant image, displays the instruction manual on the display portion 11 in a form corresponding to the mounted state of the optional equipments, and when the displayed contents are related to a method for setting the function and are not the contents to be mask-displayed, the setting instruction receipt relevant image Im is displayed together. Thereby, the user is capable of viewing information on the function that can be set in the MFP 2 on the display screen of the PC 1, and to give a setting instruction by depressing the “YES” button BT 1 when desires to set the function.

Based on whether or not the depression of the “YES” button BT 1 is detected, the PC 1 determines whether or not the user desires the setting, and determines whether to perform the setting of the function of the MFP 2 (for example, a 2-sided copying function or the like) being displayed on the display portion 11 (step S4).

When the depression of the “YES” button BT 1 in the setting instruction receipt relevant image Im is detected and the setting of the function being displayed is performed (Yes at step S4), the PC 1, based on a page number being displayed, refers to the information for a relevant image in the storage portion 13 and specifies the function being displayed, so as to register as a setting desired function (step S5), and the procedure proceeds to the step S6. Note that, when the setting for the setting item being displayed is not performed at step S4 (in the case of NO), the procedure proceeds to the step S6.

At step S6, the PC 1 determines whether or not a display of other functions is made by a user's operation. When the display of other functions is made (in the case of YES), the procedure returns to step S4, and an operation of depressing the “YES” button BT 1 is waited again, and in accordance with the result, the setting of the function being displayed is performed, whereby, in the present device setting system, it is possible to register a plurality of functions. Note that, the PC may display names of functions and the like on the display portion 11 so that the user is capable of confirming registered functions at all times.

When the display of other functions is not made by the user's operation at step S6 (in the case of NO), the PC 1 determines at a predetermined timing (for example, after a setting instruction completion is input by the user) whether or not the setting desired function is registered in the storage portion 13 (step S7). When being not registered (in the case of NO), the PC 1 finishes the processing by finishing the application and the like, whereas, when being registered (in the case of YES), the PC 1 extracts the setting instruction information on the registered function from the storage portion 13 so as to transmit through the communication I/F 14 to the MFP 2. Note that, before extracting the setting instruction information, for example, a list of registered functions may be displayed on the display portion 11 so as to cause the user to confirm the set contents.

The MFP 2 receives the setting instruction information so that the setting of the registered function (setting desired function) can be performed in itself, based on the received setting instruction information. Note that, the setting instruction information that the MFP 2 receives is, for example, a setting program capable of setting the function by execution, and any form may be taken as long as the setting of the function of the MFP 2 can be performed based on that.

Note that, when the remote setting is performed for a device that is operated by another user as described above, the following is possible using an operation portion constituted by a display panel 21 and an operation panel 22 of the MFP.

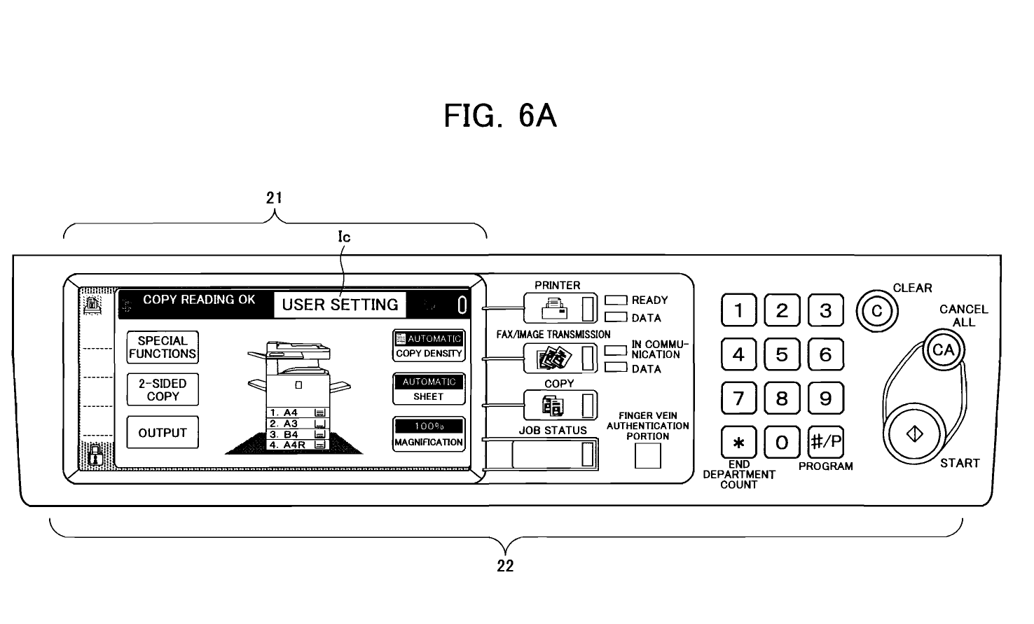

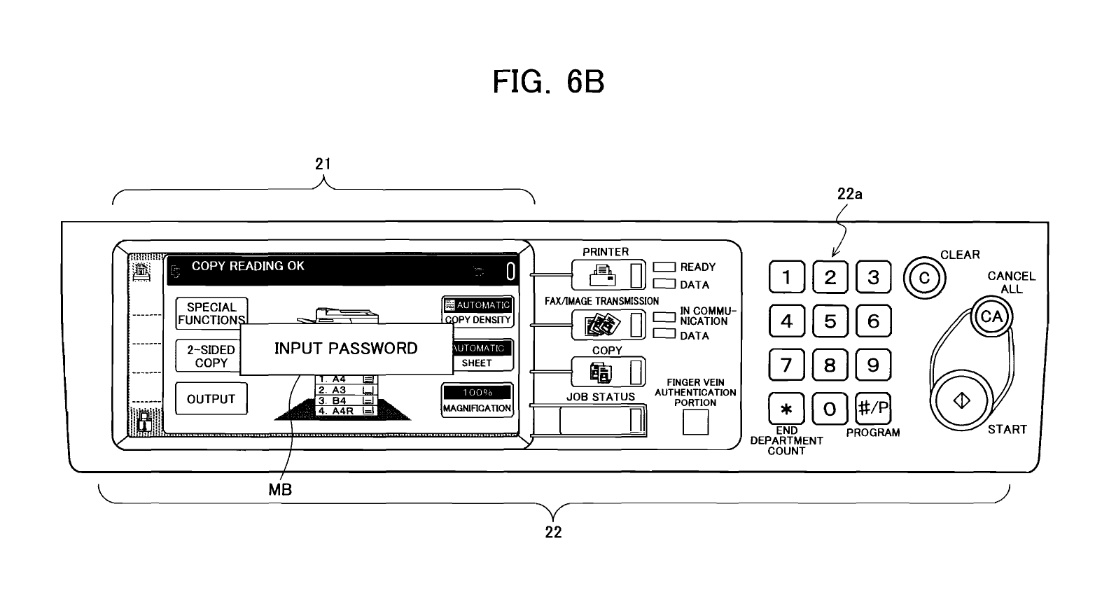

As shown in FIG. 6A, in the MFP 2, the micro-computer 20 displays an icon (“user setting”) Ic that receives an instruction from a user to execute a setting based on the received setting instruction information on the display panel 21 of the operation portion. When an operation by the user to the icon Ic is received through a touch panel of the operation panel 22, the setting of the setting instruction information that has been received is performed. With this configuration, the setting of the MFP 2 is not changed until the icon Ic is operated, thereby preventing interference with an operation by another user.

Moreover, in such a case, it is preferable that the PC 1 send authentication information (password) together with the setting instruction information. When the MFP 2 receives the operation to the icon Ic, as shown in FIG. 6B, the icon Ic on the display panel 21 is not displayed, as well as, a message box MB including a message to prompt the user to input a password is displayed, and after the same password as the received one is input from a numeric keypad 22a of the operation panel 22, the setting of the function desired by the user is preferably performed based on the received instruction setting information.

Further, in the examples above, when a request for a remote setting of the MFP 2 or the like is made, the contents other than the contents independent from a presence/absence of the mounted optional equipment and the contents relating to the mounted optional equipment are controlled so as to be mask-displayed, but may be controlled so as not to be displayed.

Note that, in such a case, the following is preferable.

That is, in the PC 1, when a request for a remote setting of the MFP 2 is made, based on the instruction manual information, the mounted state information and the page number information for each apparatus, the contents of the instruction manual may be edited based on page numbers to create instruction manual information after edition that describes only the contents relating to the current MFP 2. At this time, the information for a relevant image corresponding to the instruction manual information before edition is also edited so as to correspond to the instruction manual information after edition, and information for a relevant image after edition is created. When the CPU 10 performs display control based on the instruction manual information after edition and the information for a relevant image after edition, it is possible to perform the display as described above. Further, at that time, it is possible to extract the setting instruction information based on the information for a relevant image after edition and the currently displayed page number.

According to the present invention, the following effects can be obtained.

According to the present invention, it is possible to execute a setting operation for a function of a device reliably while referring to an instructional description displayed in a form corresponding to a mounted state of an optional equipment to the device. In addition, since the instructional description is displayed in a form corresponding to a mounted state of the optional equipment, it is possible to prevent a user from judging that a function that is not mounted is available and from erroneously inputting to set.

1. A device setting system constituted by connecting a device capable of mounting various optional equipments and a device setting apparatus provided with a display portion, wherein
the device setting apparatus comprising:
a storage portion for storing an instruction manual including descriptions of various functions of the device, a mounted state of the optional equipments of the device and setting instruction information on the respective functions, as well as storing parts where the descriptions of the functions exist in the instruction manual for each of the functions;
a display control portion in which, at the time of displaying the descriptions on the display portion, a display form is differentiated between a case where the description about the functions mounted with the device is displayed and a case where the description about a function not mounted is displayed, and when the description about the functions mounted with the device is displayed, a setting instruction receiving portion for receiving an instruction for a setting of the functions is displayed together; and
a transmitting portion in which, when the setting instruction receiving portion receives the instruction for the setting, the setting instruction information for the functions is transmitted to the device; and
the device comprising:
a receiving portion for receiving the setting instruction information; and
a setting portion for performing the setting of the functions to the device based on the setting instruction information thus received.

2. The device setting system as defined in claim 1, wherein the instruction manual further includes contents relating to the optional equipments, the storage portion stores parts where the contents relating to the optional equipments exist in the instruction manual for each of the optional equipments, and when displaying the contents relating to the optional equipments, the display control portion differentiates a display form between a case where the contents about the optional equipments mounted with the device are displayed and other cases.

3. The device setting system as defined in claim 1 or 2, wherein the transmitting portion temporarily stores the setting instruction information and transmits a plurality of the setting instruction information collectively to the device.
